(19) United States
(12) Patent Application Publication
(10) Pub. No.: US 2014/0315633 A1
(43) Pub. Date: Oct. 23, 2014

(54) Game Machine

(71) Applicant: OMRON CORPORATION, Kyoto-shi (JP)

(72) Inventors: Tatsuya ADACHI, Ichinomiya-shi (JP); Mitsunori SUGIURA, Ama-gun (JP)

(73) Assignee: OMRON CORPORATION, Kyoto-shi (JP)

(21) Appl. No.: 14/217,659

(22) Filed: Mar. 18, 2014

(30) Foreign Application Priority Data
Apr. 18, 2013 (JP) 2013-087477

(51) Int. Cl. A63F 13/219

(52) U.S. Cl. CPC A63F 13/04
USPC 463/31

(57) ABSTRACT

A game machine includes a subject specifying unit configured to specify a subject included in each of a plurality of images consecutively captured by an imaging unit, a movement detecting unit configured to detect movement of the subject along a first direction vertical to an imaging surface of the imaging unit based on an area and a luminance of the subject in each of the plurality of images, and a performance executing unit configured to execute a first performance corresponding to the first direction when the movement detecting unit detects movement of the subject along the first direction.

### CROSS REFERENCE TO RELATED APPLICATION

This application is related to and claims the benefit of Japanese Application No. 2013-087477 filed on 18 Apr. 2013, the contents of which are herein incorporated by reference in their entirety.

### BACKGROUND

1. Field

The present invention relates to a game machine.

2. Related Art

Japanese Unexamined Patent Publication No. 2012-196351 discloses providing motion sensors in a horizontal direction and a vertical direction on a periphery of a game board of a Pachinko game machine, to detect horizontal and vertical positions of a player's hand by use of the motion sensors. Japanese Unexamined Patent Publication No. 2006-145456 discloses extracting an individual shape of a moving object by means of information of an image captured by an imaging unit, to specify a human body.

### BRIEF SUMMARY

A game machine is provided including a subject specifying unit configured to specify a subject included in each of a plurality of images consecutively captured by an imaging unit, a movement detecting unit configured to detect movement of the subject along a first direction vertical to an imaging surface of the imaging unit based on an area and a luminance of the subject in each of the plurality of images, and a performance executing unit configured to execute a first performance corresponding to the first direction when the movement detecting unit detects movement of the subject along the first direction.

### BRIEF DESCRIPTION OF THE DRAWINGS

FIG. 1 is a view showing an example of a schematic front view of a game machine provided with a movement detecting device according to the present embodiment;

FIG. 2 is a view showing an example of an external perspective view of the movement detecting device according to the present embodiment;

FIG. 3 is a view showing an example of movement of a hand as a detection object;

FIG. 4 is a view showing an example of images in the case of moving the hand in a Z-axis minus direction with a wrist taken as a base point;

FIG. 5 is a diagram showing an example of a functional block of the game machine according to the present embodiment;

FIG. 6 is a diagram showing an example of a functional block of the movement detecting device according to the present embodiment;

FIG. 7A is a diagram for explaining labeling processing;

FIG. 7B is a diagram for explaining labeling processing;

FIG. 8 is a flowchart showing an example of a processing procedure for an image analysis unit;

FIG. 9A is a flowchart showing an example of a procedure for a movement detecting unit performing movement detection processing to detect movement of a subject;

FIG. 9B is a flowchart showing an example of a procedure for a movement detecting unit performing movement detection processing to detect movement of a subject;

FIG. 9C is a flowchart showing an example of a procedure for a movement detecting unit performing movement detection processing to detect movement of a subject;

FIG. 10 is a flowchart showing an example of a processing procedure for the game machine when a game ball enters a winning hole;

FIG. 11A is a view showing an example of performance screens that are displayed in the case of winning;

FIG. 11B is a view showing an example of performance screens that are displayed in the case of winning; and

FIG. 11C is a view showing an example of performance screens that are displayed in the case of winning.

### DETAILED DESCRIPTION

Although the present invention will be described below through an embodiment of the present invention, the following embodiment does not restrict the invention according to the Claims. Further, all combinations of characteristics described in the embodiment are not necessarily essential for the solving means of the invention.

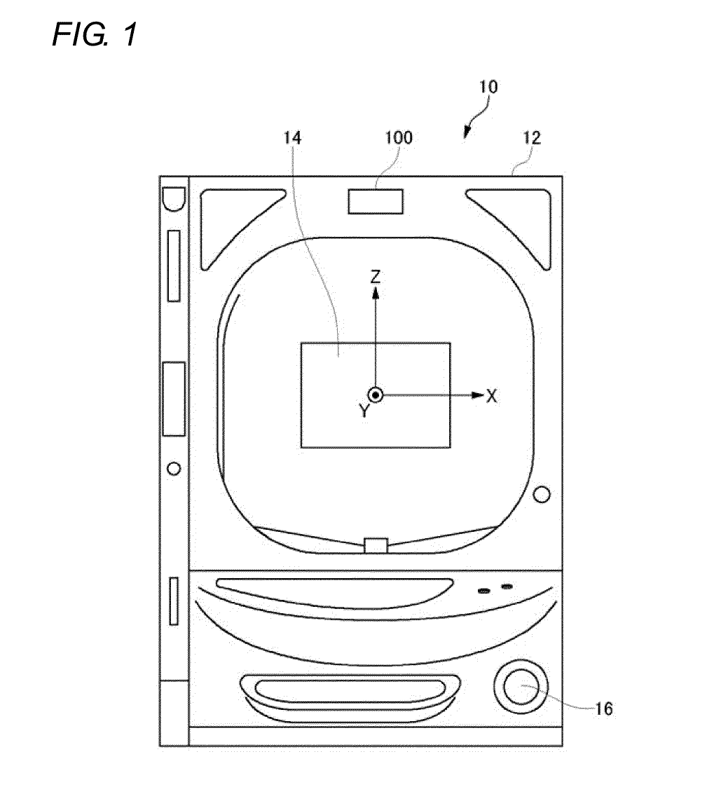

FIG. 1 is a view showing an example of a schematic front view of a game machine 10 provided with a movement detecting device 100 according to the present embodiment. The game machine 10 is provided with a casing 12, a display device 14, a handle switch 16 and the movement detecting device 100. In the present embodiment, an example of the game machine 10 provided with the movement detecting device 100 will be described. However, the movement detecting device 100 may be provided in a device other than the game machine 10.

The display device 14 is arranged in a game region of the casing 12. The display device 14 displays a variety of images for performance. The display device 14 is provided with a display screen such as a liquid crystal display. With the advancement of a game by a player, for example, the display device 14 displays a decoration design for notifying the player of a design lottery result or displays a performance image by appearance of a character or an item. The handle switch 16 is operated by the player in the case of launching a game ball via a ball launch device. The movement detecting device 100 detects movement of a subject such as a player's hand in a detection object region. In accordance with a result of the detection of movement of the subject, the detection being performed by the movement detecting device 100, the game machine 10 executes performance of displaying an image in the display device 14 or some other performance.

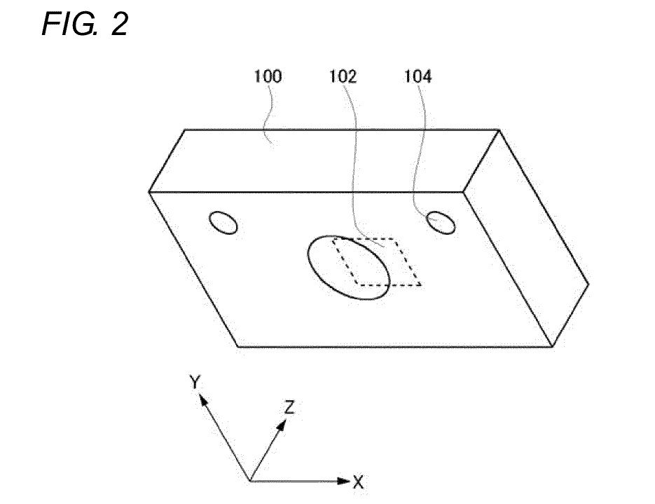

FIG. 2 is a view showing an example of an external perspective view of the movement detecting device 100. The movement detecting device 100 is provided with an imaging unit 102 and an infrared light emitting unit 104. The infrared light emitting unit 104 irradiates the detection object region for the subject with infrared rays. The imaging unit consecutively captures a plurality of images in accordance with a received light amount of reflected light of specific-wavelength light with which the detection object region for detecting movement of the subject is irradiated. The imaging unit 102 has a visible-light cut filter, an imaging element and an image generating unit. The visible-light cut filter filters out visible light out of the reflected light having been reflected on the subject, and transmits infrared light therethrough. The imaging element performs photoelectric conversion on the infrared light transmitted through the visible-light cut filter, and outputs an image signal. The image generating unit performs image processing on the image signal outputted from the imaging element, thereby generating an image.

The movement detecting device 100, for example, takes a player's hand as a subject and detects movement of the player's hand along an X-axis direction, a Y-axis direction and a Z-axis direction. It is to be noted that a first direction vertical to an imaging surface of the imaging unit 102, namely a light-receiving surface of the imaging element, is set to the Z-axis direction, a second direction parallel to the imaging surface is set to the X-axis direction, and a third direction parallel to the imaging surface and vertical to the second direction is set to the Y-axis direction.

Here, in the case of the subject moving away from the imaging unit 102 along a Z-axis direction, namely in the case of the subject moving in the Z-axis minus direction, it is considered that an area of the subject gradually becomes smaller. Further, in the case of the subject moving closer to the imaging unit 102 along a Z-axis direction, namely in the case of the subject moving in a Z-axis plus direction, it is considered that the area of the subject gradually becomes larger. It is thus considered that the movement detecting device 100 detects movement of the subject along the Z-axis direction based on a variation in area of the subject included in the image captured by the imaging unit 102.

Further, it is considered that the movement detecting device 100 detects movement of the subject along the X-axis direction or the Y-axis direction parallel to the imaging surface based on a variation in gravity-center coordinates of the subject included in the image captured by the imaging unit 102.

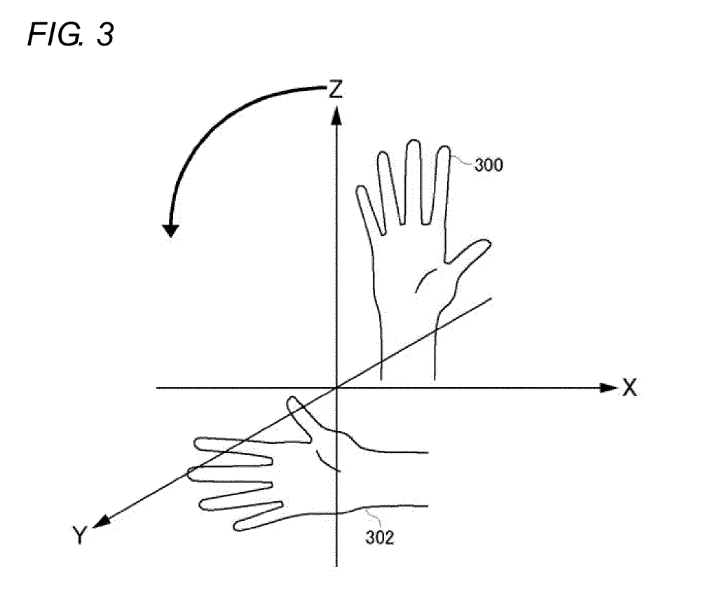

However, as shown in FIG. 3, when the player moves his or her hand in the Z-axis minus direction with its wrist taken as a base point so as to bring the state of the hand from numeral 300 to numeral 302, in the case of detecting movement of the subject based only on the variation in area of the subject within the image or the variation in gravity-center coordinates, it may not be possible to accurately detect movement of the subject.

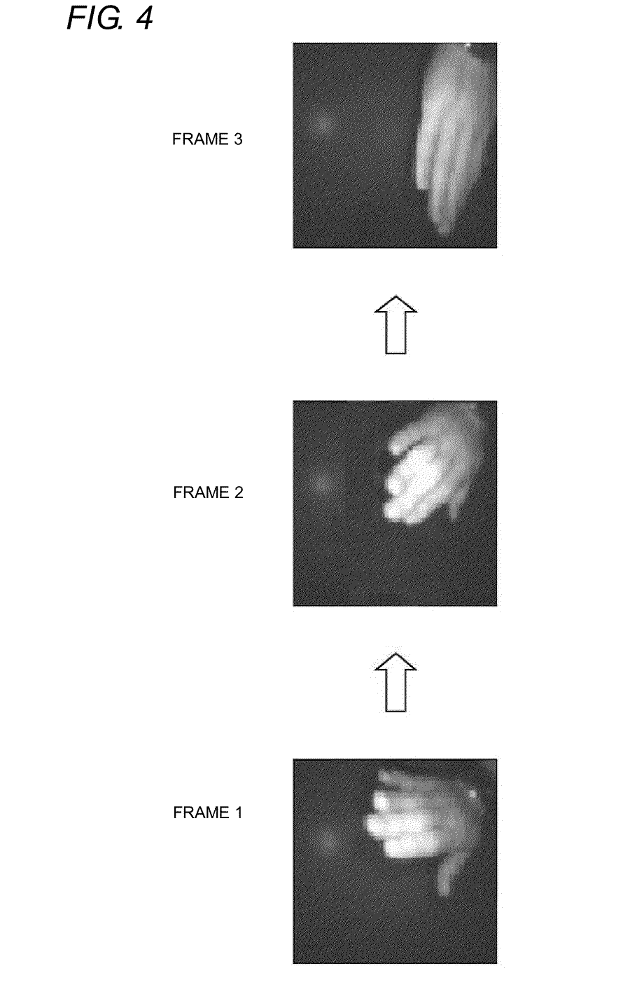

FIG. 4 is a view showing an example of images outputted from the imaging unit 102 in the case of moving the hand in the Z-axis minus direction with the wrist taken as the base point. For example, in the case of movement in the Z-axis direction with the wrist taken as the base point, there is a small variation in area of the subject since a portion from the wrist to finger tips is constantly included in the image as the subject. Further, in the case of movement in the Z-axis direction with the wrist taken as the base point, a direction of the hand included in the image changes, and the area of the subject does not become smaller. As the subject moves away from the imaging unit 102, the area of the subject becomes larger. Moreover, in the case of movement in the Z-axis direction with the wrist taken as the base point, the gravity-center coordinates of the subject also move in the X-axis direction and the Y-axis direction. Therefore, when detection is performed on movement of the subject along the X-axis direction, the Y-axis direction and the Z-axis direction based only on the variation in gravity-center coordinates or area of the subject, it may not be possible to accurately detect movement of the subject, depending on the movement of the subject.

Hence the movement detecting device 100 according to the present embodiment detects movement of the subject based on a variation in luminance of the subject in addition to the variation in gravity-center coordinates of the subject and the variation in area of the subject.

Here, as the distance between the subject and the imaging unit 102 is longer, the infrared light reflected on the subject is disadvantageously diffused. Therefore, as the distance between the subject and the imaging unit 102 is longer, the amount of the infrared light incident on the imaging unit 102 is smaller. That is, as the distance between the subject and the imaging unit 102 is longer, the luminance of the subject included in the image is lower. Therefore, when the luminance of the subject varies to be lower, the subject may be moving in the Z-axis minus direction. Further, when the luminance of the subject varies to be higher, the subject may be moving in the Z-axis plus direction.

Meanwhile, even in the case of the subject moving in the X-axis direction or the Y-axis direction, the luminance of the subject may vary. Therefore, it may be not possible to accurately detect movement of the subject just by detecting movement of the subject only based on the variation in luminance of the subject. Further in the case of movement in the Z-axis direction with the wrist taken as the base point, the gravity-center coordinates of the subject also move in the X-axis direction and the Y-axis direction. However, the variation amount of the gravity-center coordinates due to movement of the hand in the Z-axis direction with the wrist taken as the base point is likely to be smaller than the variation amount of the gravity-center coordinates due to movement of the hand in the X-axis direction or the Y-axis direction.

Therefore, when the variation amount of the gravity-center coordinates of the subject is not smaller than a previously set threshold A, the movement detecting device 100 detects movement of the subject in the X-axis direction or the Y-axis direction based on the variation in gravity-center coordinates. On the other hand, when the variation amount of the gravity-center coordinates of the subject is smaller than the threshold A and not smaller than a threshold B which is smaller than the threshold A , the movement detecting device 100 detects movement of the subject in the Z-axis direction based on the variations in the area and luminance of the subject.

As thus described, the movement detecting device 100 according to the present embodiment selects any parameter out of the variation in gravity-center coordinates of the subject, the variation in area of the subject and the variation in luminance of the subject, thereby accurately detecting movement of the subject.

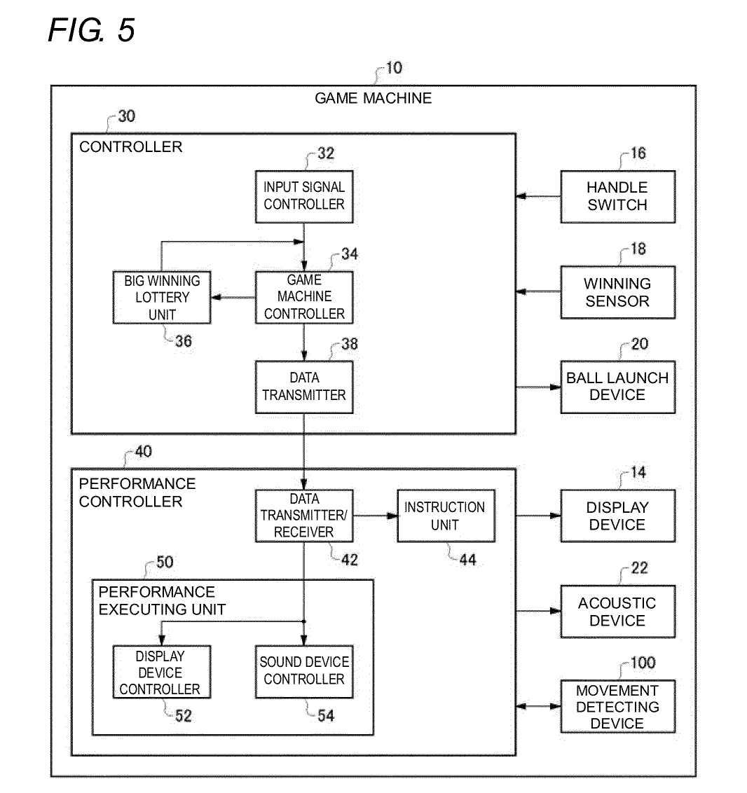

FIG. 5 is an example of a functional block of the game machine 10 according to the present embodiment. In the present embodiment, the game machine 10 is a pachinko machine. However, the game machine 10 may be another game machine such as a pachinko-slot machine.

The game machine 10 is provided with the display device 14, the handle switch 16, a winning sensor 18, a ball launch device 20, an acoustic device 22, a controller 30, a performance controller 40, and the movement detecting device 100.

The display device 14 displays an image corresponding to performance that is executed with advancement of a game by the player. The handle switch 16 launches a game ball via the ball launch device 20 in accordance with an operation by the player. The winning sensor 18 detects entry of the game ball into a previously set winning hole on the game board, and outputs a winning signal. The ball launch device 20 launches the game ball in accordance with an operation amount of the handle switch 16. The acoustic device 22 outputs a voice corresponding to performance that is executed with advancement of the game by the player.

The controller 30 controls the whole of the game machine 10. The controller 30 is provided with an input signal controller 32, a game machine controller 34, a big winning lottery unit 36, and a data transmitter 38. The input signal controller 32 senses input of the winning signal from the winning sensor 18, and notifies the game machine controller 34 of a lottery signal. When sensing the lottery signal from the input signal controller 32, the game machine controller 34 notifies the big winning lottery unit 36 of the lottery signal, and receives a lottery result from the big winning lottery unit 36. Further, the game machine controller 34 outputs a performance command in accordance with the lottery result to the performance controller 40 via the data transmitter 38. The big winning lottery unit 36 performs big winning lotteries in accordance with the lottery signal from the game machine controller 34, and notifies the game machine controller 34 of a lottery result. The data transmitter 38 transmits the performance command from the game machine controller 34 to the performance controller 40.

The performance controller 40 has a data transmitter/receiver 42, an instruction unit 44 and a performance executing unit 50. The performance executing unit 50 includes a display device controller 52 and a sound device controller 54. The data transmitter/receiver 42 receives the performance command from the controller 30 and the movement detection result from the movement detecting device 100, and outputs a performance execution command to the instruction unit 44 and the performance executing unit 50 in accordance with the movement detection result.

When the movement detection result satisfies previously set game conditions, the instruction unit 44 instructs the player to move the hand in a moving direction corresponding to the game conditions. When the movement detection result satisfies a previously set first game condition, the instruction unit 44 functions as a first instruction unit which instructs the player to move the hand in the first direction (Z-axis direction), e.g., in a bottom-to-top direction or a top-to-bottom direction with respect to the game machine. When the movement detection result satisfies a previously set second game condition, the instruction unit 44 functions as a second instruction unit which instructs the player to move the hand in the second direction (X-axis direction), e.g., in a left-to-right direction or a right-to-left direction with respect to the game machine. When the movement detection result satisfies a previously set third game condition, the instruction unit 44 functions as a third instruction unit which instructs the player to move the hand in the third direction (Y-axis direction), e.g., in a front-to-back direction or a back-to-front direction with respect to the game machine. Here, the game conditions are conditions which are set based on a big winning lottery result, for example. In the case of performance that is executed for the player for example in response to having moved the hand, the instruction unit 44 instructs the player to move the hand in accordance with the performance execution command. The instruction unit 44 may make the display device 14 display a request screen which requests the player to move the hand.

The performance executing unit 50 executes performance in accordance with the performance execution command. In the case of performance that is executed in response to that the player has moved the hand in a specific moving direction, the performance executing unit 50 executes performance based on the movement detection result from the movement detecting device 100. The display device controller 52 makes the display device 14 display a performance screen in accordance with the performance execution command. The sound device controller 54 makes the acoustic device 22 output a performance sound in accordance with the performance execution command. When the movement detection result shows detection of movement of the hand along the specific moving direction in response to the instruction unit 44 instructing the player to move the hand in the specific moving direction, the performance executing unit 50 may execute performance corresponding to the specific moving direction.

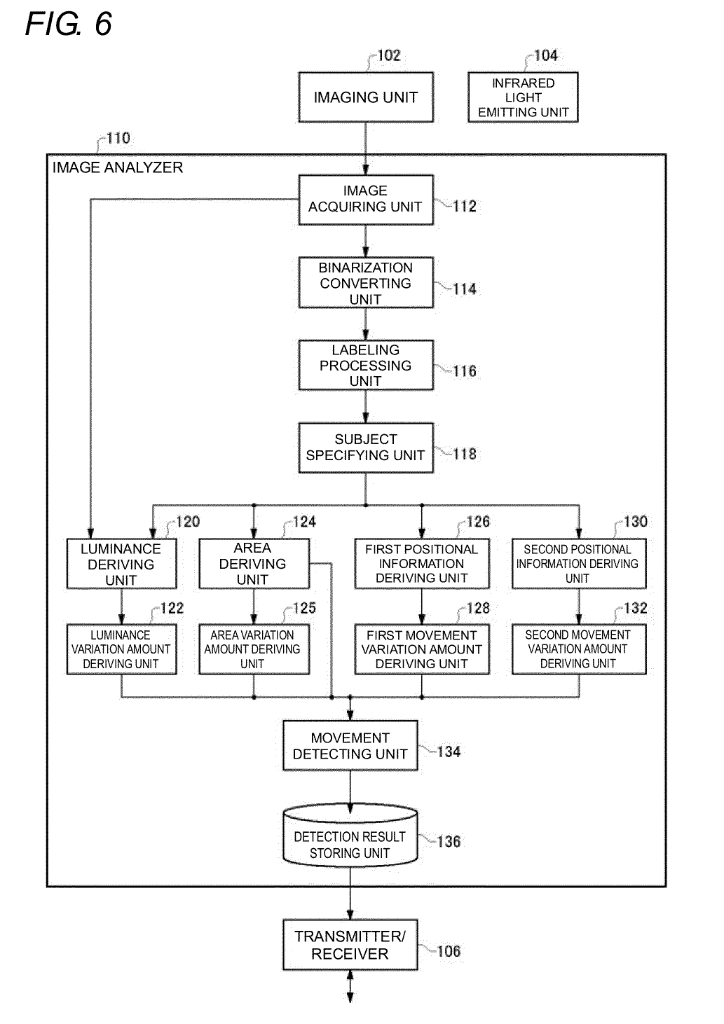

FIG. 6 is a diagram showing an example of a functional block of the movement detecting device 100. The movement detecting device 100 is provided with the imaging unit 102, the infrared light emitting unit 104, an image analyzer 110, and a transmitter/receiver 106.

The infrared light emitting unit 104 irradiates a previously set detection object region with pulse-like infrared rays. The imaging unit 102 outputs an image in accordance with the received light amount of the infrared rays reflected from the subject existing in the detection object region. The image analyzer 110 analyzes the image outputted from the imaging unit 102 to derive an image parameter for detecting movement of the subject, and detects movement of the subject based on the image parameter. The transmitter/receiver 106 receives a movement detection command from the performance controller 40, and transmits to the performance controller 40 a movement detection result as a response to the movement detection command.

The image analyzer 110 is provided with an image acquiring unit 112, a binarization converting unit 114, a labeling processing unit 116, a subject specifying unit 118, a luminance deriving unit 120, a luminance variation amount deriving unit 122, an area deriving unit 124, an area variation amount deriving unit 125, a first positional information deriving unit 126, a first movement variation amount deriving unit 128, a second positional information deriving unit 130, a second movement variation amount deriving unit 132, a movement detecting unit 134, and a detection result storing unit 136.

The image acquiring unit 112 acquires a plurality of images consecutively captured by the imaging unit 102, and provides them to the binarization converting unit 114 and the luminance deriving unit 120. The image outputted from the imaging unit 102 may be an 8-bit grayscale image showing a monochrome image where each pixel constituting the image has 256 kinds of gradation. The binarization converting unit 114 performs binarization processing on each of the provided plurality of images, and outputs the binarized images. The binarization converting unit 114 outputs the binarized image where a pixel with a luminance not lower than a previously set threshold luminance is taken as a white pixel and a pixel with a luminance lower than the threshold luminance is taken as a black pixel, out of each pixel constituting the 8-bit grayscale image.

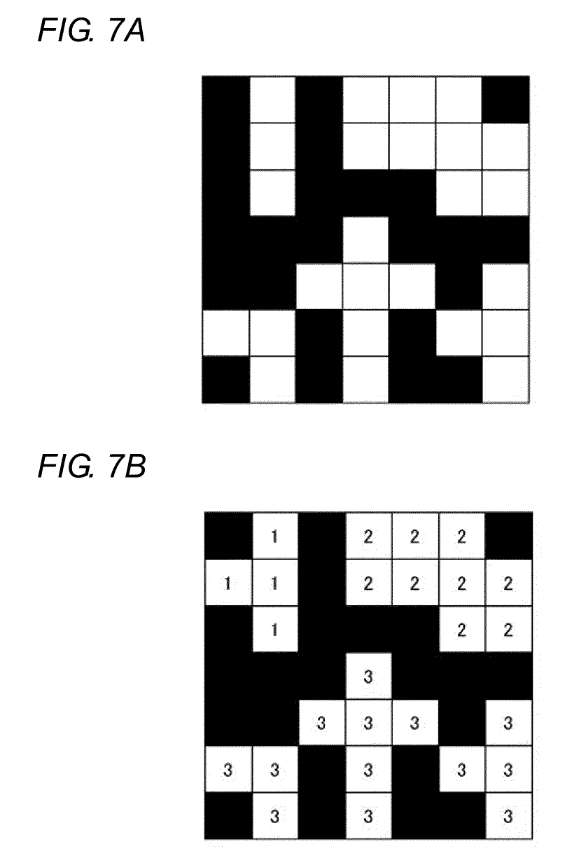

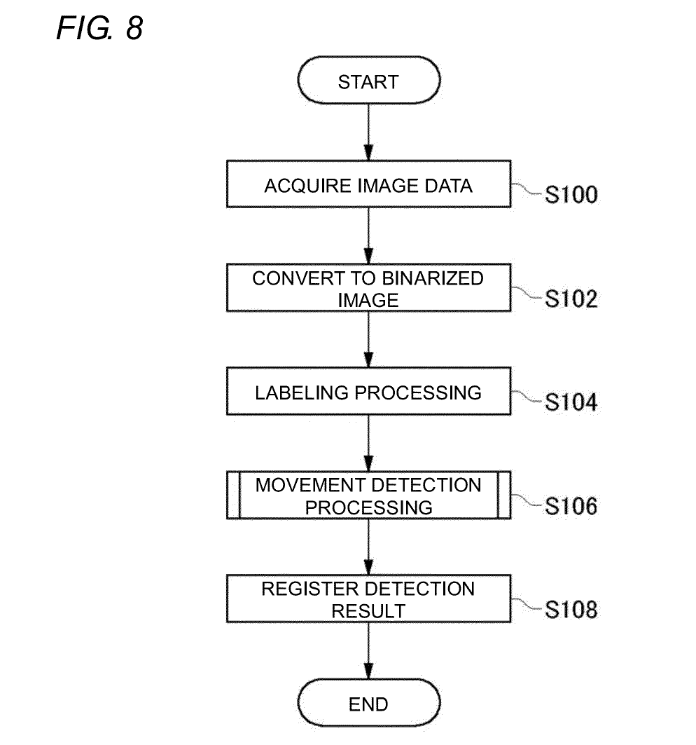

The labeling processing unit 116 provides the same label to coupled white pixels out of each pixel constituting the binarized image, to divide the white pixels that become subject candidates into groups. The labeling processing unit 116 may provide the same label to adjacent white pixels in eight directions including vertical, horizontal and oblique directions. For example, the labeling processing unit 116 performs labeling processing on a binarized image as shown in FIG. 7A, and performs labeling on each white pixel as shown in FIG. 7B. Thereby, the labeling processing unit 116 divides the white pixels which become subject candidates into groups.

The subject specifying unit 118 specifies the subject based on the binarized image subjected to the labeling processing. The subject specifying unit 118 specifies as the subject the white pixel group having the largest number of pixels provided with the same label. For example, concerning such a binarized image subjected to the labeling processing as shown in FIG. 7B, the subject specifying unit 118 specifies as the subject a white pixel group provided with a label “3”.

The luminance deriving unit 120 derives an average luminance of the subject with respect to each of a plurality of pixels. The luminance deriving unit 120 extracts each pixel corresponding to a position of the white pixel group constituting the subject specified by the subject specifying unit 118 out of each pixel constituting the 8-bit grayscale image. The luminance deriving unit 120 may derive an average luminance of a luminance (gradation value) of each extracted pixel, as a luminance of the subject.

The luminance variation amount deriving unit 122 derives a difference in luminance of the subject from one image and the other image prior thereto, to derive a luminance variation amount. The luminance variation amount deriving unit 122 derives a difference between a luminance E1 of the subject included in the latest image and a luminance E2 of the subject included in an image which is one image prior to the latest image, as a luminance variation amount H1 (E1−E2). Further, the luminance variation amount deriving unit 122 derives a difference between the luminance E2 of the subject included in the image which is one image prior to the latest image and a luminance E3 of the subject included in an image which is two images prior to the latest image, as a luminance variation amount H2 (E2−E3).

The area deriving unit 124 derives an area of the subject in each of the plurality of images. The area deriving unit 124 may derive the number of white pixel groups constituting the subject specified by the subject specifying unit 118, thereby deriving and outputting the area of the subject in each of the plurality of pixels.

The area variation amount deriving unit 125 derives a difference in area of the subject between one image and the other image prior thereto, to derive an area variation amount. The area variation amount deriving unit 125 derives a difference between an area S1 of the subject included in the latest image and an area S2 of the subject included in an image which is one image prior to the latest image, as an area variation amount J1 (S1−S2). Further, the area variation amount deriving unit 125 derives a difference between the area S2 of the subject included in the image which is one image prior to the latest image and an area S3 of the subject included in an image which is two images prior to the latest image, as an area variation amount J2 (S2−S3).

The first positional information deriving unit 126 derives as first positional information an X-coordinate of the gravity center of the subject in each of the plurality of images. The first movement variation amount deriving unit 128 derives a variation amount of the X-coordinate of the gravity center of the subject in each of one image and the other image prior thereto, as a variation amount of movement of the subject along the X-axis direction. The first movement variation amount deriving unit 128 derives a difference between an X-coordinate x1 of the gravity center of the subject included in the latest image and an X-coordinate x2 of the gravity center of the subject included in an image which is one image prior to the latest image, as a variation amount X1 (x1−x2) of movement along the X-axis direction. Further, the first movement variation amount deriving unit 128 derives a difference between the X-coordinate x2 of the gravity center of the subject included in the image which is one image prior to the latest image and an X-coordinate x3 of the gravity center of the subject included in an image which is two images prior to the latest image, as a variation amount X2 (x2−x3) of movement along the X-axis direction.

The second positional information deriving unit 130 derives as second positional information a Y-coordinate of the gravity center of the subject in each of the plurality of images. The second movement variation amount deriving unit 132 derives a variation amount of the Y-coordinate of the gravity center of the subject in each of one image and the other image prior thereto, as a variation amount of movement of the subject along the Y-axis direction. The second movement variation amount deriving unit 132 derives a difference between a Y-coordinate y1 of the gravity center of the subject included in the latest image and a Y-coordinate y2 of the gravity center of the subject included in an image which is one image prior to the latest image, as a variation amount Y1 (y1−y2) of movement along the Y-axis direction. Further, the second movement variation amount deriving unit 132 derives a difference between the Y-coordinate y2 of the gravity center of the subject included in the image which is one image prior to the latest image and a Y-coordinate y3 of the gravity center of the subject included in an image which is two images prior to the latest image, as a variation amount Y2 (y2−y3) of movement along the Y-axis direction.

The movement detecting unit 134 detects movement of the subject based on the luminance variation amount and the area variation amount of the subject and the movement variation amounts of the subject along the X-axis direction and the Y-axis direction, and registers the movement detection result into the detection result storing unit 136.

When a magnitude (absolute value) of the movement variation amount of the subject along the X-axis direction is not smaller than a first reference amount, the movement detecting unit 134 may detect movement of the subject along the X-axis direction based on the movement variation amount of the subject along the X-axis direction. When the movement variation amount of the subject along the X-axis direction is not smaller than a previously set threshold A or not larger than a threshold −A, the movement detecting unit 134 may detect movement of the subject along the X-axis direction.

When the magnitude (absolute value) of the movement variation amount of the subject along the X-axis direction is smaller than the first reference amount and not smaller than a second reference amount which is smaller than the first reference amount, the movement detecting unit 134 may detect movement of the subject along the Z-axis direction based on the area variation amount and the luminance variation amount of the subject. When the movement variation amount of the subject along the X-axis direction is smaller than the threshold A and not smaller than a previously set threshold B, the movement detecting unit 134 may detect movement of the subject along the Z-axis direction based on the area variation amount and the luminance variation amount of the subject. When the movement variation amount of the subject along the X-axis direction is larger than the threshold −A and not larger than a previously set threshold −B, the movement detecting unit 134 may detect movement of the subject along the Z-axis direction based on the area variation amount and the luminance variation amount of the subject.

When a magnitude (absolute value) of the movement variation amount of the subject along the Y-axis direction is not smaller than a third reference amount, the movement detecting unit 134 may detect movement of the subject along the Y-axis direction based on the movement variation amount of the subject along the Y-axis direction. When the movement variation amount of the subject along the Y-axis direction is not smaller than the threshold A and not larger than the threshold −A, the movement detecting unit 134 may detect movement of the subject along the Y-axis direction.

When the magnitude of the movement variation amount of the subject along the Y-axis direction is smaller than the third reference amount and not smaller than a fourth reference amount which is smaller than the third reference amount, the movement detecting unit 134 may detect movement of the subject along the Z-axis direction based on the area variation amount and the luminance variation amount of the subject. When the magnitude of the movement variation amount of the subject along the X-axis direction is smaller than the first reference amount and not smaller than the second reference amount and the magnitude of the movement variation amount of the subject along the Y-axis direction is smaller than the third reference amount and not smaller than the fourth reference amount which is smaller than the third reference amount, the movement detecting unit 134 may detect movement of the subject along the Z-axis direction based on the area variation amount and the luminance variation amount of the subject.

When the movement variation amount of the subject along the Y-axis direction is smaller than the threshold A and is not smaller than the threshold B, the movement detecting unit 134 may detect movement of the subject along the Z-axis direction. When the movement variation amount of the subject along the Y-axis direction is larger than the threshold −A and is not larger than the threshold −B, the movement detecting unit 134 may detect movement of the subject along the Z-axis direction based on the area variation amount and the luminance variation amount of the subject.

When the movement variation amount of the subject along the X-axis direction is smaller than the threshold A and not smaller than the threshold B and the movement variation amount of the subject along the Y-axis direction is smaller than the threshold A and not smaller than the threshold B, the movement detecting unit 134 may detect movement of the subject along the Z-axis direction based on the area variation amount and the luminance variation amount of the subject. When the movement variation amount of the subject along the X-axis direction is larger than the threshold −A and not larger than the threshold -B and the movement variation amount of the subject along the Y-axis direction is larger than the threshold −A and not larger than the threshold −B, the movement detecting unit 134 may detect movement of the subject along the Z-axis direction based on the area variation amount and the luminance variation amount of the subject.

The transmitter/receiver 106 outputs the movement detection result registered in the detection result storing unit 136 to the performance controller 40 in accordance with a request from the performance controller 40. In order to determine whether the subject, for example the player's hand, has moved along a moving direction corresponding to executable performance, the performance controller 40 makes a request of the movement detecting device 100 for a movement detection result of the subject along the moving direction. Upon receipt of the request, the transmitter/receiver 106 references the movement detection result registered in the detection result storing unit 136, and transmits to the performance controller 40 the movement detection result showing whether or not the subject has moved along the instructed moving direction (X-axis direction, Y-axis direction, or Z-axis direction).

It is to be noted that the performance controller 40 or the controller 30 of the game machine 10 may be provided with part of functions which are provided in the movement detecting device 100. For example, the performance controller 40 may be provided with the movement detecting unit 134 and the detection result storing unit 136. Further, the performance controller 40 may be provided with the luminance variation amount deriving unit 122, the area variation amount deriving unit 125, the first movement variation amount deriving unit 128 and the second movement variation amount deriving unit 132.

FIG. 8 is a flowchart showing an example of a processing procedure for the image analyzer 110. The image analyzer 110 regularly repeats this processing procedure. Further, the image acquiring unit 112 acquires an 8-bit grayscale image outputted from the imaging unit 102 (S100). Subsequently, the binarization converting unit 114 converts the 8-bit grayscale image to a binarized image (S102). Then, the labeling processing unit 116 executes labeling processing on the binarized image (S104). The luminance variation amount deriving unit 122, the area variation amount deriving unit 125, the first movement variation amount deriving unit 128, and the second movement variation amount deriving unit 132 derive a luminance variation amount, an area variation amount, and variation amounts of movement in the X-axis direction and the Y-axis direction. The movement detecting unit 134 detects movement of the subject based on the luminance variation amount, the area variation amount, and the variation amounts of the movement in the X-axis direction and the Y-axis direction (S106). The movement detecting unit 134 registers the movement detection result of the subject into the detection result storing unit 136 (S108).

In accordance with the above processing procedure, the image analyzer 110 updates the movement detection result of the subject every time an image is acquired.

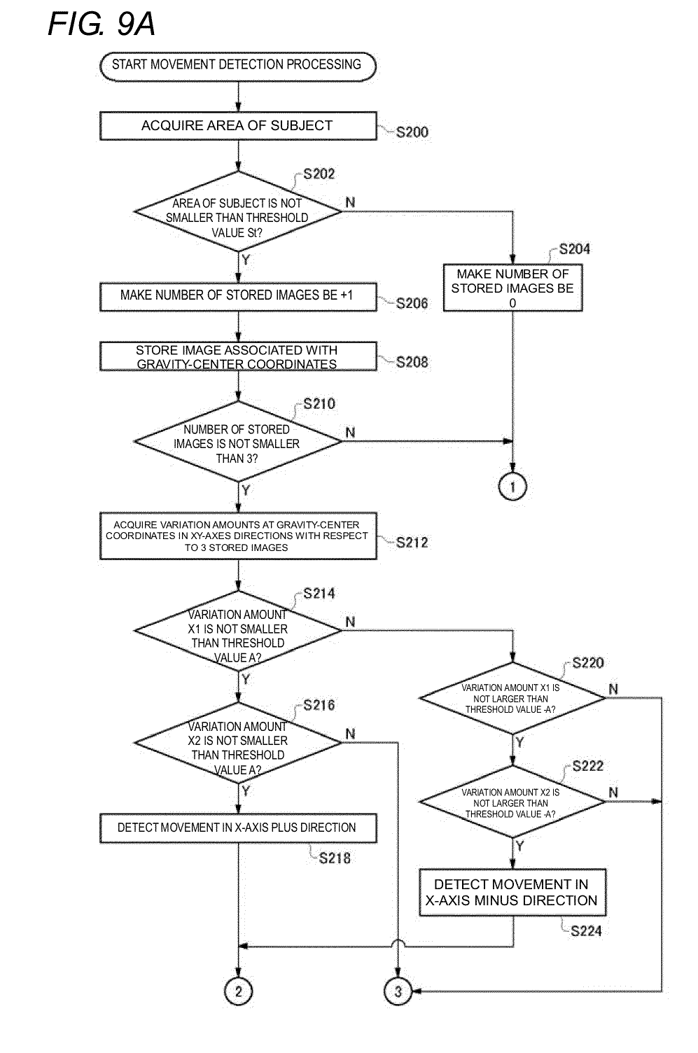

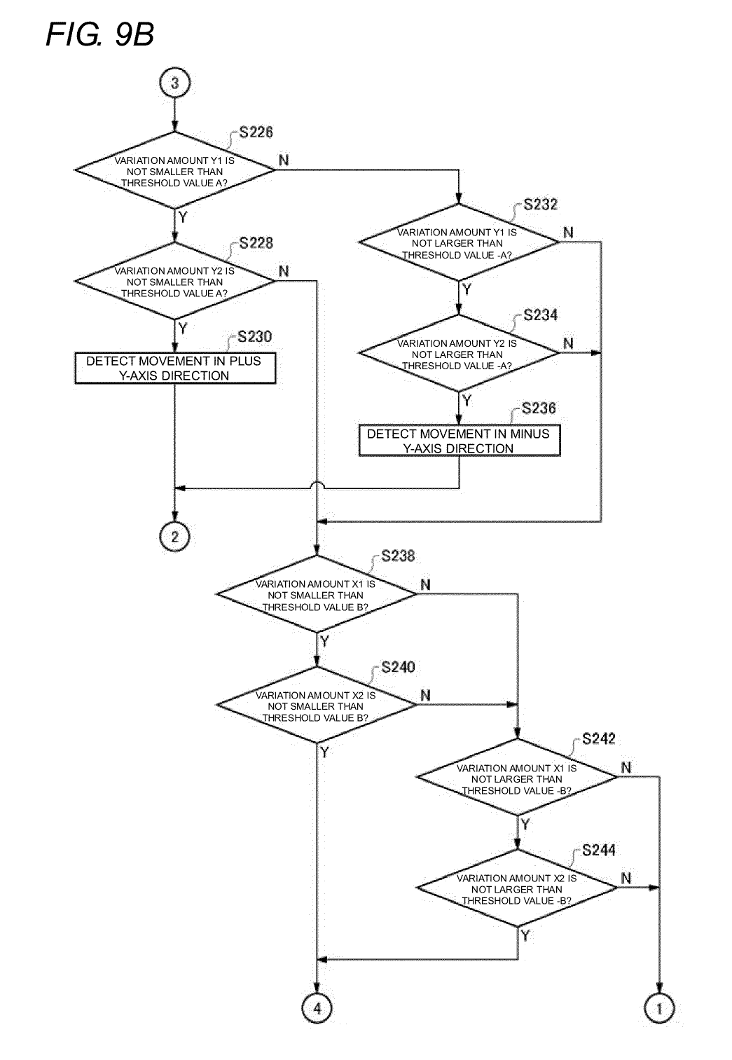

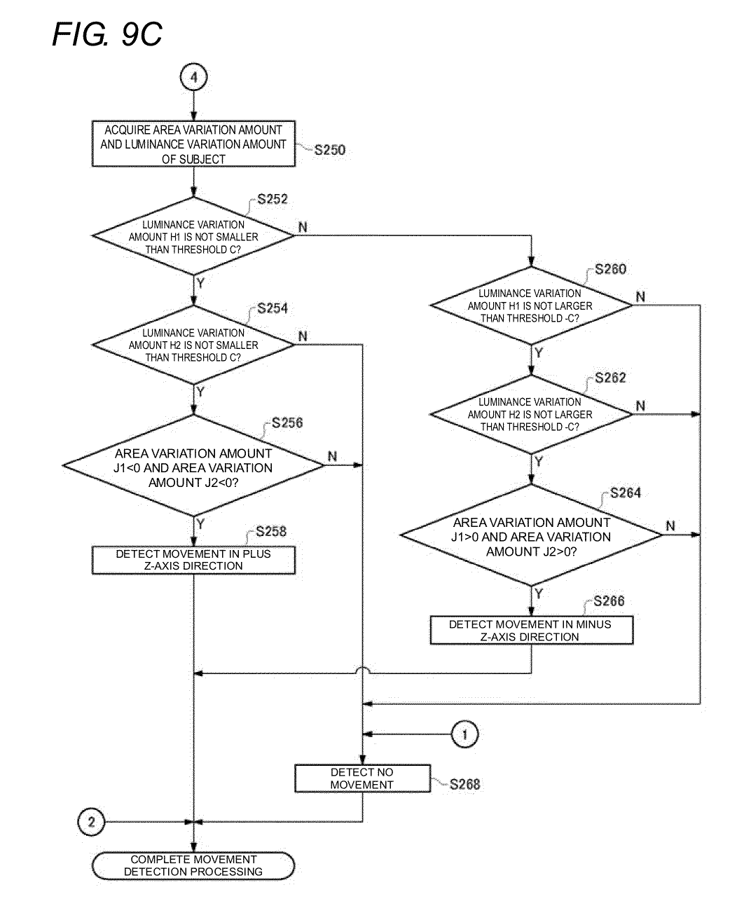

FIGS. 9A, 9B and 9C are flowcharts showing an example of a procedure for the movement detecting unit 134 performing movement detection processing to detect movement of the subject. The movement detecting unit 134 executes the movement detection processing every time the image acquiring unit 112 acquires an image.

In FIG. 9A, the movement detecting unit 134 acquires an area of the subject (S200), and determines whether or not the area of the subject is not smaller than a threshold value St (S202). When the area of the subject is not larger than the threshold St, the movement detecting unit 134 makes the number of stored images be zero (S204) and determines not to have detected movement of the subject (S268 (FIG. 9C)), and completes the movement detection processing. On the other hand, when the area of the subject is not smaller than the threshold St, the movement detecting unit 134 increments the number of stored images (S206). The movement detecting unit 134 stores the image associated with gravity-center coordinates (S208).

Then, the movement detecting unit 134 determines whether or not the number of stored images is not smaller than three (S210). When the number of stored images is smaller than three, the movement detection processing is completed. When the number of stored images is not smaller than three, the movement detecting unit 134 acquires variation amounts X1 (=x1−x2), X2 (=x2−x3), Y1 (=y1−y2) and Y2 (=y2−y3) of movement of the subject at the gravity-center coordinates in the XY-axes directions with respect to three stored images (S212). Here, x1 and y1 indicate gravity-center coordinates of the subject in the latest image I1. x2 and y2 indicate gravity-center coordinates of the subject in an image I2 which is one image prior to the latest image. x3 and y3 indicate gravity-center coordinates of the subject in an image I3 which is two images prior to the latest image.

The movement detecting unit 134 determines whether or not the variation amount X1 is not smaller than the threshold A (S214). That is, the movement detecting unit 134 determines whether or not the subject has moved in an X-axis plus direction between the image I2 and the image I1. When the variation amount X1 is not smaller than the threshold A, the movement detecting unit 134 further determines whether or not the variation amount X2 is not smaller than the threshold A (S216). When the variation amount X2 is not smaller than the threshold A, since the subject is likely to have moved in the X-axis plus direction between the image I3 and the image I1, the movement detecting unit 134 detects movement of the subject in the X-axis plus direction (S218), and completes the movement detection processing. On the other hand, when the variation amount X2 is smaller than the threshold A, since the subject is unlikely to have moved in the X-axis plus direction between the image I3 and the image I1, the movement detecting unit 134 determines that the subject has not moved in the X-axis plus direction, and the processing shifts to the next one (processing shown in FIG. 9B).

When the variation amount X1 is smaller than the threshold A, the movement detecting unit 134 determines whether or not the variation amount X1 is not larger than the threshold −A (S220). That is, the movement detecting unit 134 determines whether or not the subject has moved in an X-axis minus direction between the image I2 and the image I1. When the variation amount X1 is not larger than the threshold −A, the movement detecting unit 134 determines whether or not the variation amount X2 is not larger than the threshold −A (S222). When the variation amount X2 is not larger than the threshold −A, since the subject is likely to have moved in the X-axis minus direction between the image I3 and the image I1, the movement detecting unit 134 detects movement of the subject in the X-axis minus direction (S224), and completes the movement detection processing.

When the variation amount X1 or the variation amount X2 is larger than the threshold −A, the movement detecting unit 134 determines that the subject has not moved in the X-axis minus direction, and the processing shifts to the next one (processing shown in FIG. 9B).

In FIG. 9B, the movement detecting unit 134 determines whether or not the variation amount Y1 is not smaller than the threshold A (S226). That is, the movement detecting unit 134 determines whether or not the subject has moved in a Y-axis plus direction between the image I2 and the image I1. When the variation amount Y1 is not smaller than the threshold A, the movement detecting unit 134 further determines whether or not the variation amount Y2 is not smaller than the threshold A (S228). When the variation amount Y2 is not smaller than the threshold A, since the subject is likely to have moved in the Y-axis plus direction between the image I3 and the image I1, the movement detecting unit 134 detects movement of the subject in the Y-axis plus direction (S230), and completes the movement detection processing. On the other hand, when the variation amount Y2 is smaller than the threshold A, since the subject is unlikely to have moved in the Y-axis plus direction between the image I3 and the image I1, the movement detecting unit 134 determines that the subject has not moved in the Y-axis plus direction, and the processing shifts to the next one (S238). When the variation amount Y1 is smaller than the threshold A, the movement detecting unit 134 determines whether or not the variation amount Y1 is not larger than the threshold −A (S232). That is, the movement detecting unit 134 determines whether or not the subject has moved in a Y-axis minus direction between the image I2 and the image I1. When the variation amount Y1 is not larger than the threshold −A, the movement detecting unit 134 determines whether or not the variation amount Y2 is not larger than the threshold −A (S234). When the variation amount Y2 is not larger than the threshold −A, since the subject is likely to have moved in the Y-axis minus direction between the image I3 and the image I1, the movement detecting unit 134 detects movement of the subject in the Y-axis minus direction (S236), and completes the movement detection processing.

When the variation amount Y1 or the variation amount Y2 is larger than the threshold −A, the movement detecting unit 134 determines that the subject has not moved in the Y-axis minus direction, and the processing shifts to the next one (S238).

When determining that the subject has not moved in the X-axis direction and the Y-axis direction, the movement detecting unit 134 determines whether or not the variation amount X1 is not smaller than the threshold B which is smaller than the threshold A in order to determine the possibility for movement of the subject in the Z-axis direction (S238). When the variation amount X1 is not smaller than the threshold B, the movement detecting unit 134 further determines whether or not the variation amount X2 is not smaller than the threshold B (S240). When the variation amount X2 is not smaller than the threshold B, since there is a possibility of the subject having moved in the Z-axis direction, the processing shifts to the next processing for determining whether or not the subject has moved in the Z-axis direction (processing shown in FIG. 9C). When the variation amount X1 or X2 does not satisfy the condition of the threshold B, the movement detecting unit 134 determines not to have detected movement of the subject (S268 (FIG. 9C)), and completes the movement detection processing.

In FIG. 9C, the movement detecting unit 134 acquires the luminance variation amounts H1 (=E1−E2) and H2 (=E2−E3) of the subject and the area variation amounts J1 (=S1−S2) and J2 (=S2−S3) of the subject (S250). Here, E1 and S1 show a luminance and an area of the subject in the latest image I1. E2 and S2 show a luminance and an area of the subject in the latest image I2. E3 and S3 show a luminance and an area of the subject in the image I3.

The movement detecting unit 134 determines whether or not the luminance variation amount H1 is not smaller than a threshold C (S252). That is, the movement detecting unit 134 determines whether or not the subject has become brighter between the image I2 and the image I1. When the luminance variation amount H1 is not smaller than the threshold C, the movement detecting unit 134 further determines whether or not the luminance variation amount H2 is not smaller than the threshold C (S254). When the luminance variation amount H2 is not smaller than the threshold C, the movement detecting unit 134 determines whether or not the area variation amounts J1 and J2 are smaller than zero (S256). That is, the movement detecting unit 134 determines whether or not the area of the subject gradually becomes smaller between the image I3 and the image I1.

When the area variation amounts J1 and J2 are smaller than zero, the movement detecting unit 134 detects that the subject has moved in the Z-axis plus direction, namely the subject has moved to the imaging unit 102 side (S258), and completes the movement detection processing. When the variation amount H2 is smaller than the threshold C or at least one of the area variation amounts J1 and J2 is not smaller than zero, the movement detecting unit 134 determines not to have detected movement of the subject (S268), and completes the movement detection processing.

When the luminance variation amount H1 is not larger than the threshold C, the movement detecting unit 134 determines whether or not the luminance variation amount H1 is not smaller than a threshold −C (S260). That is, the movement detecting unit 134 determines whether or not the subject has become darker between the image I2 and the image I1. When the luminance variation amount H1 is not larger than the threshold −C, the movement detecting unit 134 further determines whether or not the luminance variation amount H2 is not larger than the threshold −C (S262). When the luminance variation amount H2 is not larger than the threshold −C, the movement detecting unit 134 determines whether or not the area variation amounts J1 and J2 are larger than zero (S264). That is, the movement detecting unit 134 determines whether or not the area of the subject gradually becomes larger between the image I3 and the image I1.

When the area variation amounts J1 and J2 are larger than zero, the movement detecting unit 134 detects that the subject has moved in the Z-axis minus direction, namely the subject has moved to the opposite side to the imaging unit 102 (S266), and completes the movement detection processing. When the variation amount H1 or H2 is larger than the threshold −C or at least one of the area variation amounts J1 and J2 is not larger than zero, the movement detecting unit 134 determines not to have detected movement of the subject (S268), and completes the movement detection processing.

As thus described, the movement detecting unit 134 determines whether or not there is a possibility of the subject having moved in the Z-axis direction in accordance with the magnitude of the movement variation amount of the subject along the XY-axes. When determining that there is a possibility of the subject having moved in the Z-axis, the movement detecting unit 134 detects movement of the subject in the Z-axis direction based on the area variation amount and the luminance variation of the subject. Therefore, the movement detecting unit 134 can more accurately detect movement of the player's hand which moves along the Z-axis direction with the wrist thereof taken as the base point, for example.

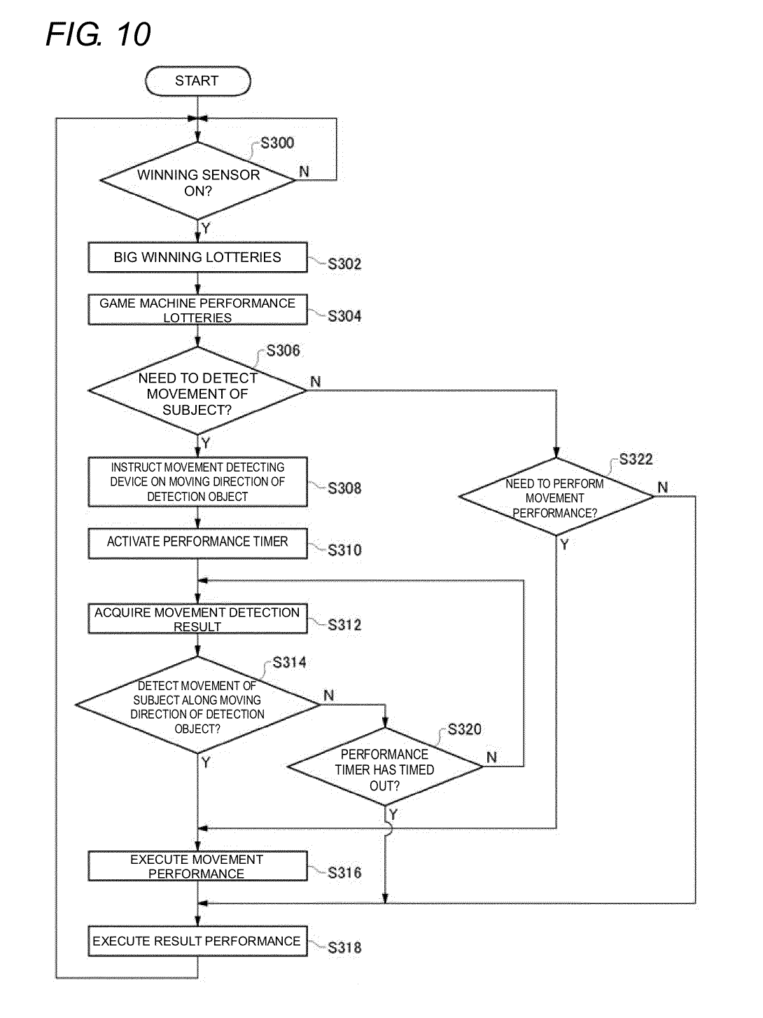

FIG. 10 is a flowchart showing an example of a processing procedure for the game machine 10 when the game ball enters the winning hole.

When receiving a winning signal from the winning sensor 18 (S300), the input signal controller 32 makes the big winning lottery unit 36 execute big winning lotteries (S302). Upon receipt of a result of the big winning lotteries, the game machine controller 34 executes game machine performance lotteries in order to decide contents of the game machine performance (S304). As a result of the game machine performance lotteries, the game machine controller 34 transmits a performance command showing the decided performance contents to the performance controller 40 via the data transmitter 38.

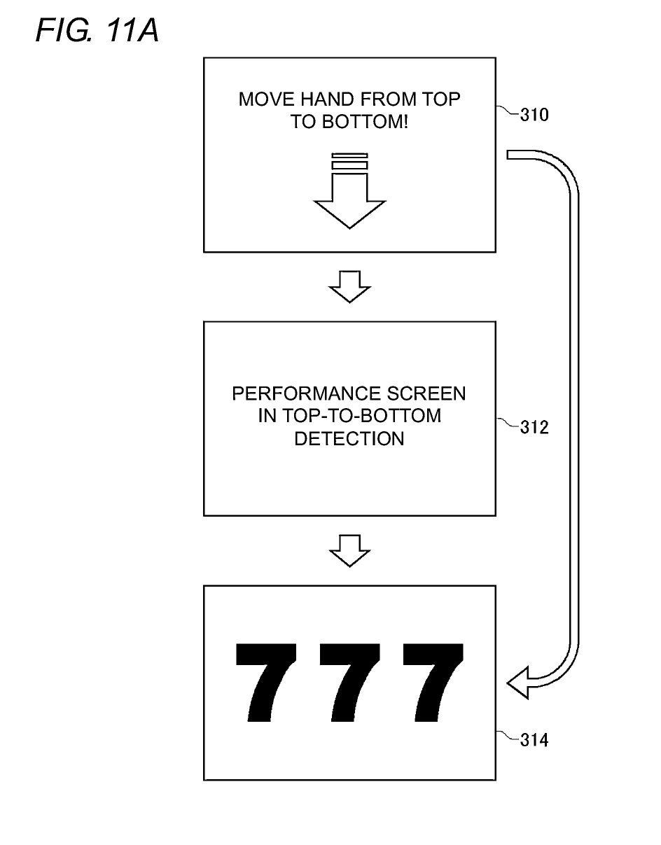

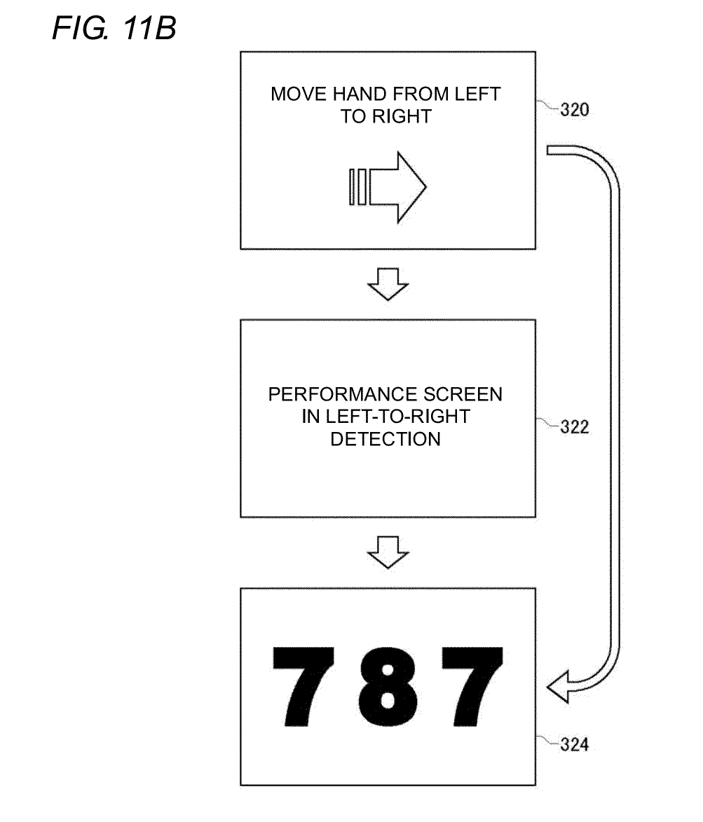

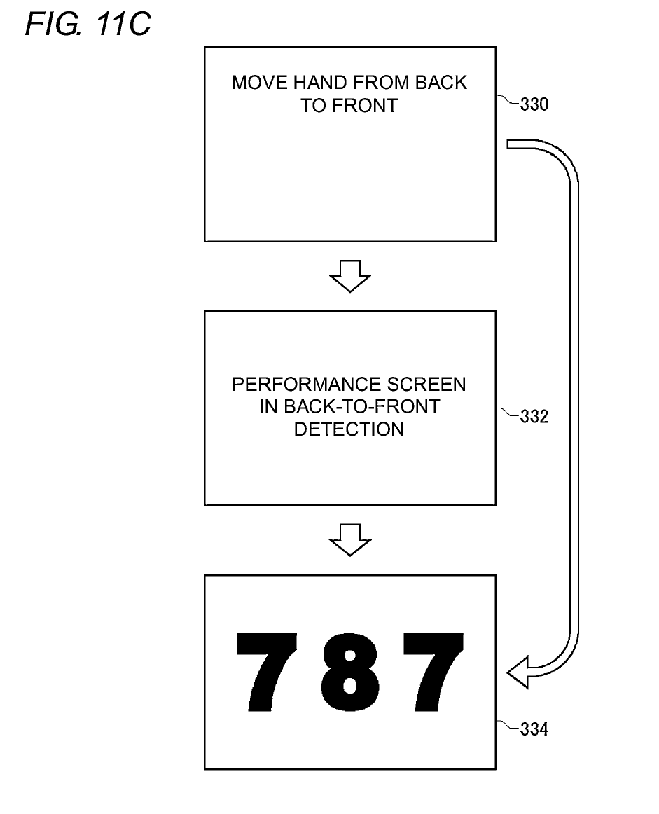

In order to execute performance shown by the performance command, the performance controller 40 determines whether or not there is a need to detect movement of the subject (S306). When there is a need to detect movement of the moving object, such as movement of the player's hand in a specific moving direction, the instruction unit 44 makes the display device 14 display a request screen which requests the player to move the hand in the specific direction. For example, the instruction unit 44 makes the display device 14 display screens as shown in a screen 310 of FIG. 11A, a screen 320 of FIG. 11B and a screen 330 of FIG. 11C, to request the player to move the hand in the specific moving direction.

Further, in order to make a request of the movement detecting device 100 for the movement detection result of the subject in the specific moving direction, the performance controller 40 instructs the movement detecting device 100 about the moving direction of the detection object (S308), and activates a performance timer (S310).

Subsequently, the performance controller 40 acquires the movement detection result of the subject with respect to the moving direction of the detection object from the movement detecting device 100 (S312). Based on the movement detection result, the performance executing unit 50 determines whether or not to have detected movement of the subject in the moving direction of the detection object (S314). When movement of the subject in the moving direction of the detection object is detected, the performance executing unit 50 executes performance for movement detection in accordance with the moving direction of the detection object, as movement performance (S316). The display device controller 52, for example, displays an image in which a character moves in the moving direction of the detection object, and the sound device controller 54 makes the acoustic device 22 output a sound in accordance with the image. The display device controller 52, for example, makes the display device 14 display screens in accordance with the moving direction such as a screen 312 of FIG. 11A as an example of first performance, a screen 322 of FIG. 11B as an example of second performance and a screen 332 of FIG. 11C as an example of third performance.

After execution of the movement performance in accordance with the moving direction of the detection object, the performance executing unit 50 executes performance for lottery result for notifying a result of big winning lotteries, as result performance (S318). The display device controller 52 makes the display device 14 display a lottery result screen indicating the result of the big winning lotteries. The display device controller 52, for example, makes the display device 14 display lottery result screens as shown in a screen 314 of FIG. 11A, a screen 324 of FIG. 11B, and a screen 334 of FIG. 11C.

When movement of the subject in the moving direction of the detection object is not detected, the performance controller 40 determines whether or not the performance timer times out (S320). When the performance timer has not timed out, the performance controller 40 again acquires a movement detection result of the subject from the movement detecting device 100. When the performance timer has timed out, the performance executing unit 50 does not execute the performance for movement detection as the movement performance, but executes the performance for lottery result for notifying a result of big winning lotteries as the result performance (S318).

When there is no need to detect movement of the moving object, the performance controller 40 determines whether or not there is a need to execute the movement performance before executing the result performance (S322). When there is a need to execute the movement performance, the performance executing unit 50 executes, as the movement performance, performance of displaying a screen in which a character moves or some other performance before notifying the lottery result as in the case of detecting movement of the subject (S312). When there is no need to execute the movement performance, the performance executing unit 50 executes the performance for lottery result as the result performance (S318).

As described above, according to the game machine 10 of the present embodiment, it is possible to execute performance in accordance with a result of detection of movement of the subject in the X, Y, Z-axes directions, the detection being performed by the movement detecting device 100.

It is to be noted that each unit provided in the movement detecting device 100 according to the present embodiment may be configured by being stored into a computer-readable record medium, installing a program for performing a variety of pieces of processing regarding detection of movement of the subject, and making the computer execute this program. That is, the movement detecting device 100 may be configured by making the computer execute a program for performing a variety of pieces of processing regarding detection of movement of the subject to make the computer function as each unit provided in the movement detecting device 100.

The computer has a communication bus, an interface and a variety of memories such as a CPU, a ROM, a RAM and an EEPROM (registered trademark), and the CPU reads and sequentially executes processing programs previously stored into the ROM as firmware. Accordingly, the computer functions as the movement detecting device 100.

Although the present invention has been described above using the embodiment, the technical scope of the present invention is not restricted to the scope according to the above embodiment. It is obvious for the person skilled in the field that a variety of modifications and improvements can be made in the above embodiment. It is apparent that a form in which modifications or improvements have made can be included in the technical scope of the present invention.

It should be noted that the executing order of each processing of the operation, the procedure, the step, the stage and the like in the device, the system, the program and the method as disclosed herein is not particularly demonstrated using terms such as “earlier than”, “prior to” and the like, and so long as an output in some processing is not used in processing thereafter, the processing can be realized in an arbitrary order. The description uses terms such as “first” and “next” for convenience, it does not mean that it is essential to execute the operations in this order.

As described herein, a game machine according to one aspect of the present invention is provided with: a subject specifying unit configured to specify a subject included in each of a plurality of images consecutively captured by an imaging unit; a movement detecting unit configured to detect movement of the subject along a first direction vertical to an imaging surface of the imaging unit based on an area and a luminance of the subject in each of the plurality of images; and a performance executing unit configured to execute first performance corresponding to the first direction when the movement detecting unit detects movement of the subject along the first direction.

The game machine is further provided with a first instruction unit configured to instruct the player to move his or her hand in the first direction when a previously set first game condition is satisfied. The subject specifying unit may specify as the subject the player's hand included in each of the plurality of images, and the performance executing unit may execute the first performance when the movement detecting unit detects movement of the hand along the first direction in response to the first instruction unit instructing the player to move his or her hand in the first direction.

The game machine is further provided with: an area variation amount deriving unit configured to derive a variation amount of the area of the subject in the plurality of images; and a luminance variation amount deriving unit configured to derive a variation amount of the luminance of the subject in the plurality of images. The movement detecting unit may detect movement of the subject along the first direction based on the area variation amount and the luminance variation amount.

The game machine is further provided with a first movement variation amount deriving unit configured to derive a variation amount of movement along a second direction parallel to the imaging surface of the subject in the plurality of images. The movement detecting unit may detect movement of the subject along the second direction based on the variation amount of the movement along the second direction when the variation amount of the movement along the second direction is not smaller than a first reference amount, and the movement detecting unit may detect movement of the subject along the first direction based on the area variation amount and the luminance variation amount when the variation amount of the movement along the second direction is smaller than the first reference amount and not smaller than a second reference amount which is smaller than the first reference amount. The performance executing unit may execute second performance corresponding to the second direction when the movement detecting unit detects movement of the subject along the second direction.

The game machine is further provided with a second instruction unit configured to instruct the player to move his or her hand in the second direction when a previously set second game condition is satisfied. The performance executing unit may execute the second performance when the movement detecting unit detects movement of the hand along the second direction in response to the second instruction unit instructing the player to move his or her hand in the second direction.

The game machine is further provided with a second movement variation amount deriving unit configured to derive a variation amount of movement along a third direction that is parallel to the imaging surface of the subject and different from the second direction, in the plurality of images. The movement detecting unit may detect movement of the subject along the third direction based on a variation amount of the movement along the third direction when the variation amount of the movement along the third direction is not smaller than a third reference amount, and the movement detecting unit may detect movement of the subject along the first direction based on the area variation amount and the luminance variation amount when the variation amount of the movement along the second direction is smaller than the first reference amount and not smaller than the second reference amount and the variation amount of the movement along the third direction is smaller than the third reference amount and not smaller than a fourth reference amount which is smaller than the third reference amount. The performance executing unit may execute third performance corresponding to the third direction when the movement detecting unit detects movement of the subject along the third direction.

The game machine is further provided with a third instruction unit configured to instruct the player to move his or her hand in the third direction when a previously set third game condition is satisfied. The performance executing unit may execute the third performance when the movement detecting unit detects movement of the hand along the third direction in response to the third instruction unit instructing the player to move his or her hand in the third direction.

In the game machine, the imaging unit consecutively may capture the plurality of images in accordance with a received light amount of reflected light of specific-wavelength light with which the detection object region for detecting movement of the subject is irradiated.

In the game machine, the movement detecting unit may detect that the subject moves in a direction closer to the imaging unit along the first direction when the area of the subject varies to be smaller and the luminance of the object varies to be higher.

In the game machine, the movement detecting unit may detect that the subject moves in a direction away from the imaging unit along the first direction when the area of the subject varies to be larger and the luminance of the object varies to be lower.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A game machine, comprising:
a subject specifying unit configured to specify a subject included in each of a plurality of images consecutively captured by an imaging unit;
a movement detecting unit configured to detect movement of the subject along a first direction vertical to an imaging surface of the imaging unit based on an area and a luminance of the subject in each of the plurality of images; and
a performance executing unit configured to execute a first performance corresponding to the first direction when the movement detecting unit detects movement of the subject along the first direction.

2. The game machine according to claim 1, further comprising
a first instruction unit configured to instruct a player to move his or her hand in the first direction when a previously set first game condition is satisfied,
wherein the subject specifying unit is configured to specify as the subject the player's hand included in each of the plurality of images, and
wherein the performance executing unit is configured to execute the first performance when the movement detecting unit detects movement of the hand along the first direction in response to the first instruction unit instructing the player to move his or her hand in the first direction.

3. The game machine according to claim 1, further comprising:
an area variation amount deriving unit configured to derive a variation amount of the area of the subject in the plurality of images; and
a luminance variation amount deriving unit configured to derive a variation amount of the luminance of the subject in the plurality of images,
wherein the movement detecting unit is configured to detect movement of the subject along the first direction based on the area variation amount and the luminance variation amount.

4. The game machine according to claim 3, further comprising:
a first movement variation amount deriving unit configured to derive a variation amount of movement along a second direction parallel to the imaging surface of the subject in the plurality of images,
wherein the movement detecting unit is configured to detect movement of the subject along the second direction based on the variation amount of the movement along the second direction when the variation amount of the movement along the second direction is not smaller than a first reference amount,
wherein the movement detecting unit is configured to detect movement of the subject along the first direction based on the area variation amount and the luminance variation amount when the variation amount of the movement along the second direction is smaller than the first reference amount and not smaller than a second reference amount which is smaller than the first reference amount, and
wherein the performance executing unit is configured to execute second performance corresponding to the second direction when the movement detecting unit detects movement of the subject along the second direction.

5. The game machine according to claim 4, further comprising
a second instruction unit configured to instruct the player to move his or her hand in the second direction when a previously set second game condition is satisfied,
wherein the performance executing unit is configured to execute the second performance when the movement detecting unit detects movement of the hand along the second direction in response to the second instruction unit instructing the player to move his or her hand in the second direction.

6. The game machine according to claim 4, further comprising
a second movement variation amount deriving unit configured to derive a variation amount of movement along a third direction that is parallel to the imaging surface of the subject and different from the second direction, in the plurality of images,
wherein the movement detecting unit is configured to detect movement of the subject along the third direction based on a variation amount of the movement along the third direction when the variation amount of the movement along the third direction is not smaller than a third reference amount,
wherein the movement detecting unit is configured to detect movement of the subject along the first direction based on the area variation amount and the luminance variation amount when the variation amount of the movement along the second direction is smaller than the first reference amount and not smaller than the second reference amount and the variation amount of the movement along the third direction is smaller than the third reference amount and not smaller than a fourth reference amount which is smaller than the third reference amount, and
wherein the performance executing unit is configured to execute third performance corresponding to the third direction when the movement detecting unit detects movement of the subject along the third direction.

7. The game machine according to claim 6, further comprising
a third instruction unit configured to instruct the player to move his or her hand in the third direction when a previously set third game condition is satisfied,
wherein the performance executing unit is configured to execute the third performance when the movement detecting unit detects movement of the hand along the third direction in response to the third instruction unit instructing the player to move his or her hand in the third direction.

8. The game machine according to claim 1, wherein the imaging unit is configured to consecutively capture the plurality of images in accordance with a received light amount of reflected light of specific-wavelength light with which the detection object region for detecting movement of the subject is irradiated.

9. The game machine according to claim 1, wherein the movement detecting unit is configured to detect that the subject moves in a direction closer to the imaging unit along the first direction when the area of the subject varies to be smaller and the luminance of the object varies to be higher.

10. The game machine according to claim 1, wherein the movement detecting unit is configured to detect that the subject moves in a direction away from the imaging unit along the first direction when the area of the subject varies to be larger and the luminance of the object varies to be lower.

11. The game machine according to claim 2, further comprising:
an area variation amount deriving unit configured to derive a variation amount of the area of the subject in the plurality of images; and
a luminance variation amount deriving unit configured to derive a variation amount of the luminance of the subject in the plurality of images,
wherein the movement detecting unit is configured to detect movement of the subject along the first direction based on the area variation amount and the luminance variation amount.

12. The game machine according to claim 11, further comprising:
a first movement variation amount deriving unit configured to derive a variation amount of movement along a second direction parallel to the imaging surface of the subject in the plurality of images,
wherein the movement detecting unit is configured to detect movement of the subject along the second direction based on the variation amount of the movement along the second direction when the variation amount of the movement along the second direction is not smaller than a first reference amount,
wherein the movement detecting unit is configured to detect movement of the subject along the first direction based on the area variation amount and the luminance variation amount when the variation amount of the movement along the second direction is smaller than the first reference amount and not smaller than a second reference amount which is smaller than the first reference amount, and
wherein the performance executing unit is configured to execute second performance corresponding to the second direction when the movement detecting unit detects movement of the subject along the second direction.

13. The game machine according to claim 12, further comprising
a second instruction unit configured to instruct the player to move his or her hand in the second direction when a previously set second game condition is satisfied,
wherein the performance executing unit is configured to execute the second performance when the movement detecting unit detects movement of the hand along the second direction in response to the second instruction unit instructing the player to move his or her hand in the second direction.

14. The game machine according to claim 12, further comprising
a second movement variation amount deriving unit configured to derive a variation amount of movement along a third direction that is parallel to the imaging surface of the subject and different from the second direction, in the plurality of images,
wherein the movement detecting unit is configured to detect movement of the subject along the third direction based on a variation amount of the movement along the third direction when the variation amount of the movement along the third direction is not smaller than a third reference amount,
wherein the movement detecting unit is configured to detect movement of the subject along the first direction based on the area variation amount and the luminance variation amount when the variation amount of the movement along the second direction is smaller than the first reference amount and not smaller than the second reference amount and the variation amount of the movement along the third direction is smaller than the third reference amount and not smaller than a fourth reference amount which is smaller than the third reference amount, and
wherein the performance executing unit is configured to execute third performance corresponding to the third direction when the movement detecting unit detects movement of the subject along the third direction.

15. The game machine according to claim 5, further comprising
a second movement variation amount deriving unit configured to derive a variation amount of movement along a third direction that is parallel to the imaging surface of the subject and different from the second direction, in the plurality of images,
wherein the movement detecting unit is configured to detect movement of the subject along the third direction based on a variation amount of the movement along the third direction when the variation amount of the movement along the third direction is not smaller than a third reference amount,
wherein the movement detecting unit is configured to detect movement of the subject along the first direction based on the area variation amount and the luminance variation amount when the variation amount of the movement along the second direction is smaller than the first reference amount and not smaller than the second reference amount and the variation amount of the movement along the third direction is smaller than the third reference amount and not smaller than a fourth reference amount which is smaller than the third reference amount, and
wherein the performance executing unit is configured to execute third performance corresponding to the third direction when the movement detecting unit detects movement of the subject along the third direction.

16. The game machine according to claim 13, further comprising
a second movement variation amount deriving unit configured to derive a variation amount of movement along a third direction that is parallel to the imaging surface of the subject and different from the second direction, in the plurality of images,
wherein the movement detecting unit is configured to detect movement of the subject along the third direction based on a variation amount of the movement along the third direction when the variation amount of the movement along the third direction is not smaller than a third reference amount,
wherein the movement detecting unit is configured to detect movement of the subject along the first direction based on the area variation amount and the luminance variation amount when the variation amount of the movement along the second direction is smaller than the first reference amount and not smaller than the second reference amount and the variation amount of the movement along the third direction is smaller than the third reference amount and not smaller than a fourth reference amount which is smaller than the third reference amount, and
wherein the performance executing unit is configured to execute third performance corresponding to the third direction when the movement detecting unit detects movement of the subject along the third direction.

17. The game machine according to claim 14, further comprising
a third instruction unit configured to instruct the player to move his or her hand in the third direction when a previously set third game condition is satisfied,
wherein the performance executing unit is configured to execute the third performance when the movement detecting unit detects movement of the hand along the third direction in response to the third instruction unit instructing the player to move his or her hand in the third direction.

18. The game machine according to claim 15, further comprising
a third instruction unit configured to instruct the player to move his or her hand in the third direction when a previously set third game condition is satisfied,
wherein the performance executing unit is configured to execute the third performance when the movement detecting unit detects movement of the hand along the third direction in response to the third instruction unit instructing the player to move his or her hand in the third direction.

19. The game machine according to claim 16, further comprising
a third instruction unit configured to instruct the player to move his or her hand in the third direction when a previously set third game condition is satisfied,
wherein the performance executing unit is configured to execute the third performance when the movement detecting unit detects movement of the hand along the third direction in response to the third instruction unit instructing the player to move his or her hand in the third direction.
